(19) United States
(12) Patent Application Publication
(10) Pub. No.: US 2016/0210572 A1
(43) Pub. Date: Jul. 21, 2016

(54) System and method for budgeting and cash flow forecasting

(71) Applicants: Ahmed Farouk Shaaban, South Barrington, IL (US); Venkat Thandra, South Barrington, IL (US)

(72) Inventors: Ahmed Farouk Shaaban, South Barrington, IL (US); Venkat Thandra, South Barrington, IL (US)

(21) Appl. No.: 14/756,741

(22) Filed: Jun. 30, 2015

Related U.S. Application Data
(60) Provisional application No. 61/998,577, filed on Jun. 30, 2014.

(51) Int. Cl. G06Q 10/06; G06Q 40/00

(52) U.S. Cl. CPC G06Q 10/06312; G06Q 40/128

(57) ABSTRACT

The present invention consists of an improved system and method for improved budgeting and forecasting where data can be collected for prior years by account and by month, then a factor for the year may be applied to the data and reports are generated to create a budget for the upcoming year based upon inflation and cost o living, as well as other factors.

### FIELD OF THE INVENTION

The present invention relates to the automation of billing and collections, and more particularly, predicting cash flow and budgets in companies or firms.

### BACKGROUND OF THE INVENTION

In the current marketplace, there are a variety of computerized time and billing systems for professional firms which are marketed under the following trademarks: Timeslips by Sage, BillQuick, Clio and others. Some of these systems are computer based while others operate primarily in a cloud-computing environment. These systems, however, are not suited to large law firms and professional firms that have a global presence, with multiple offices in a plurality of countries, which must be linked together for proper billing and financial management. In addition, these are basic programs, which do not contain the most up to date features such as transmissions by text, email, fax, computer voice calling, social media announcements, and billing. Other numerous and varied disclosures related to billing and timekeeping are also disclosed in the prior art as shown below.

EP 1,145,162 issued to Somes discloses the use of a system for processing credit applications, financial and insurance services, as well as administrative and management tools. The system will generate a price quote for insurance and finance and facilitate online credit application processing. It will further provide detailed reports for finance, insurance inventory, tracking and other administrative matters. It will provide quick quotes for a lease or loan. It will also perform: inventory tracking, insurance tracking, purchase tracking, applicant profiling, targeted marketing, customer satisfaction, etc. The system will collect data for credit, a description of the item being sold, insurance will be offered for the item, licensing and data required for the government will be collected.

Somes also discloses that the user can be a financial institution, a dealer, manufacturer, insurer or supplier. It can utilize and store credit agreements with customer ratings and interest rates, which can be bundled and sold on a public exchange. FAQ's can be provided in the system, and it can provide quick quotes on the spot to the consumer. However, this disclosure is directed to car sales and insurance, not timekeeping. The terms it stores are contract terms, contract ID, customer ID, buy rate, the sales rate, dealer markup, payments, cash down, trade in value, lease fee, monthly payments, commission and taxes due. However, Somes does not relate to professional timekeeping or billing.

EP Patent No. 1,769,452 issued to Allin discloses the use of a computerized system for residential and commercial construction projects to maintain and disburse construction draws during construction. It can track lien waivers, and can prepare, approve, sign and distribute hundreds of checks to subcontractors each month. It also tracks construction change orders. It can manage all of the persons involved in each draw. It manages and generates a construction budget and time line. It also manages payments to material suppliers. It can manage and store the inspection data for each project. It can manage budgets for GC's as well as the subs. It handles ACH payments. Template forms are utilized to facilitate the draw process. Notices can be sent by email, text or voice.

EP Patent No. 2,026,222 issued to Alquier discloses the use of a system and method, which allows the addition, modification, and deletion of database fields dynamically without the use of a database administrator. The system allows the addition and modification of an informational structure dynamically distributed directly via the user interface. It supports different types of entity attributes including, text, numerical information, date and time, predefined values and binary objects, allows the creation of relational dependencies between information entities (e.g., patent/child), provides flexible reporting capabilities including spreadsheets, slides, documents, timelines, etc.; it allows a configurable data entry interface; it allows importation of data from external sources; it allows full text searches; logs modifications for an audit trial (important for pharma and med devices); includes email notifications. It allows for a user interface that is flexible and configurable. The system uses template items, coding and tables to accomplish these purposes. However, it is not directed toward time tracking and billing generation.

U.S. Patent Disclosure No. 2003/0120538 filed by Boerke et al. discloses the use of a method for tracking progress on a task by dividing the period of time into a plurality of timeslots and determining a target number of subtasks to be completed during each timeslot. For example, the time slots may be divided into 15-minute increments. The system only tracks the number of subtasks completed for each timeslot. The method also keeps track statistically of variances in subtasks completed between workers. The task may include any type of work. The process may be used for planning purposes, i.e., as a planning tool such that management can plan and process daily or monthly work shifts according to the work to be done for particular tasks and subtasks. This helps a supervisor spot and correct negative variances in worker performance. The progress can be logged into a computer or worksheet or in paper format. Problems are also noted by the method for correction to improve performance by variance cards.

U.S. Patent Disclosure No. 2013/0090968 filed by Borza, discloses the use of an employee management and scheduling method which is directed to ensure that adequate personnel are present as required and that statutory requirements are met and costs are tracked and minimized. The Borza disclosure is also directed at apps for management cell phone usage wherein managers can track employees, their shifts and their skills and managing same. This allows for real time changes by employees that are sick or have not shown up for work. The locations may also be tracked. Scheduling software is used to manage multiple employees at multiple locations. From one screen, a manager may create, edit and delete shifts and also have access to other aspects of managing the organization staffing with information about positions, teams, skills, etc. being provided. The system can print shift assignment reports and employee reports. However, this disclosure is directed toward scheduling employees and not tracking their time or billing for their time.

U.S. Patent Disclosure No. 2012/0233044 filed by Burger, et al., discloses the use of a Method and System for labor project management and costing which may run on a cell phone app to monitor employee activity, identify faulty activity and manage allocation of labor resources. The app, as installed on an employee cellphone, allows the employee to travel to various job locations and record the activities at each job location. The employee may log into or out of the time clock app installed on the employee's cellphone. The system can be used to monitor managers and administrators as well as employees. The system can be used to transmit payroll information. A flag may be generated if the worker travels outside the permissible areas allocated to his role. The system stores employee photos. Job locations, routes, job codes, SIC codes, etc. may be entered into the back end by an administrator. The system also generates reports, and has a “Dashboard” or summary report simply show who is on the job, what time they arrived and GPS confirmation of location. The LPM platform may also be operated in the Cloud.

U.S. Patent Disclosure No. 2014/0258057 filed by Chen et al. discloses the use of a system and method for tracking the user's time of a mobile device for the purpose of billing clients. The system is provided with a digital timer, which is launched at the time of arrival and then stopped when the employee leaves. The system is directed at tracking time on a mobile device or app. It tracks time sending texts and emails. Time is recorded as soon as the professional receives a voice mail, phone call, text or email.

The user can also input notes with the system's time recording and entry. The app automatically looks up the user's contacts list whether the call or email or text coming in is from a client, and if so, it begins to track it for billing purposes. If it is not in the contacts registry, the user is alerted at the time and can add the contact as a client to be billed.

U.S. Patent Disclosure No. 2013/0290154 filed by Cherry et al. discloses the use of the system and method to manage employees at a plurality of jobsites by providing a database wherein a set of job site data is stored therein. Employee devices may collect a set of time punch data and photos to store in the system. Management apps are used on supervisory devices to monitor the job site data and employees and can validate photos and activate employee apps. This system is shown operating on a Cloud environment. The app will operate with a web browser, Wi-Fi or on GPS authentication.

The system essentially operates as a time tracking system for job sites. The system stores time photos of the employees at check in and check out. The system also records a job number, a job phase and a cost code. The system also has a payroll calculator communicating with a payroll service.

U.S. Patent Disclosure No. 2001/0042032 filed by Chrawshaw et al. discloses the use of a system for capturing, processing and reporting time and expense data, which can include flat fee billing, maximum fee billing and will also allow for discounts and write offs. It can be used for a wide range of businesses. A client will not have access to internal data of the company. The system will produce bills, expense reports, time sheets, proposals and project tracking. This appears to be a conventional program for law firm data, which is run on a local server for one location. The system may produce various reports as needed. Bills may be delivered by email. The program will create envelopes for the bills. The system will also create budgets for the client.

U.S. Pat. No. 6,038,547 issued to Casto discloses the use of a construction tracking and payment system for use by contractors and subcontractors so that work may be tracked and payment may be timely made after the work is completed and inspections are performed. The system complies with AIA requirements. The system may be implemented on a handheld computer. The system will break down a construction job into various elements and then a contractor or subcontractor will be given a copy of how the site is partitioned. Each contractor or subcontract is then responsible for submitting applications using the partitioning to ensure the uniformity the architect desires to impose. The system can import and use CAD information on the job site. The system uses coding approved by the AIA.

U.S. Pat. No. 6,747,679 issued to Finch, I I et al. discloses the use of a timekeeping and expense tracking server including a server that implements computer instructions that define logic for building GUI screens according to user instructions. The user can implement and design the screens needed for the tasks of timekeeping and expense tracking. The system may be implemented on the Cloud or Internet with a laptop or wireless device desired. The GUI screen may be customized on a company-by-company basis, a department-by-department basis, etc. The system also includes security wherein projects and project codes are only viewable by certain level employees.

U.S. Pat. No. 7,343,316 issued to Goto et al. discloses the use of a network-based shift scheduling system for generating temporary shift workers. It is sent over portable terminals over a network. The system is set to secure and provide work for a plurality of workers. Workers can also submit cancellations or shift changes via the system. The system also accommodates email for communication purposes. The system may also recruit new employees. The system stores the name, age, sex, address, mail address and qualifications of the employee, the workable time slots, the type of job, hourly wage, etc.

WO 2014/016796 filed by Gupta et al. discloses the use of a system and method for employee tracking in a mobile communication device wherein dynamic location reports may be generated in real time or near real time. The system is directed to door-to-door delivery or pickup sales forces. The system uses a mobile app on the employee's cellphone to conduct the tracking of the employee. The system will raise flags if deviations from tracking occur. The system uses Blue Dophil software to analyze where employees should be performing tasks and produces flags when parameters gathered fall outside permissible ranges. These flags are sent to management via text or email.

U.S. Pat. No. 6,832,176 issued to Hartigan et al. discloses the use of a method and system for tracking and reporting time spent on tasks in different application on the end users' computers while the tasks are being performed. It may track the opening and closing of files automatically and send reports and messages directly to and from other applications. The software may also suggest categories for each task based upon at least one criterion. The system may use MS Outlook for assistance in tracking tasks and transmitting reports. It is directed toward attorneys and accountants. The system may track fixed fees and use data collected for evaluating production or sweat equity bonuses to employees. The system may track a plurality of projects or research endeavors. It can track the time spent by accountants on spreadsheets. It can track the time engineers spend on designing computer code or simulating circuit designs, etc. It mentions the use of time slips for professional time tracking and TABS II for tracking other professional time spent on tasks and projects. The system tracks time on computers used by the professionals involved. The system presents toolbars to assist in tracking time. The system will track time spent in applications such as MS Word, Excel, Outlook, Power Point, etc. It will track when the application is open, active and then closed. It can score and rate the usage of these various types of software automatically. Various reports may be generated by the system for management usage on a periodic basis, as desired.

WO Patent Disclosure No. 2015/079776 filed by Hishiki discloses the use of a work state management system that manages clock-in times for drivers of vehicles that work overnight shifts and calculates the appropriate breaks for the driver so that the driver is not over tired.

U.S. Patent Disclosure No. 2014/0344122 filed by Hodgin, discloses the use for billing for time spent in an IM session by a service person wherein the system can automatically bill a project/client by searching for the name of the client or project within a text or instant message or a series or session of same. If the system cannot find the name of a client or project, then the user will associate the IM session with a new project or client so that the client may be billed for the IM session with the client. The system may also default into a common template for the user's typical instant messaging sessions.

U.S. Patent Disclosure No. 2009/0006228 filed by Hodgin discloses the use of a time tracking system and method similar to the IM system noted above by Hodgin. The Hodgin system will also store a list of prior associations to projects and clients that are built on the same or similar words and phrases.

U.S. Patent Disclosure No. 2002/0154122 filed by Jackson, Jr. discloses the use of an improved system for employers, referral agencies, consultants and independent contractors to hire and manage employees and provide tax reports and wage reports. The Jackson, Jr. system may track and manage employees, salaries and experience to provide optimal benefits to the employer. The system produces computerized scheduling, billing, record keeping and payment templates. It provides a listing of invoices for the user to refer to. It consists of providing invoices for contractor services and performs its functions in a cloud-based system.

U.S. Pat. No. 8,838,486 issued to Kong, et al., discloses the use of a time manager interface on a communications display device, which allows a worker to keep track of her or his time and activities. The time manager keeps track of time spent logging into and out of the system. This was important in years past when boot times were quite long. It discloses the use of scanning employee badges to track work time. This disclosure is directed toward a system for checking work-in and work-out time. In one version of an embodiment, the system is located in the field. It discloses the use of GPS in the field to create an audit trail of time worked. Biometric information may be used for the system to identify the worker. It can be used nationwide for multiple local offices. It may be coupled to communicate with employee hand held devices. It can work over Wi-Fi and cellular networks. It can store: DOB, SSN and other employee details. It can be used with a barcode or QRT code. It can be used in connection with microphones, cameras and scanners. For remote sites, the system can check the IP address of the computer or handheld device to ensure security in the system. The system can also be used to check work schedules and to lock an employee out of the system when not scheduled. When an employee arrives at a worksite, upon verification, one or more emails or text messages may be sent to management for that site. Employees may view the work schedules of other employees if granted permission to do so. In doing so, employees can request work dates and exchange them with others. The system can differentiate between exempt and non-exempt employees. The system can display messages to employees during time-in and time-out registration.

U.S. Patent Disclosure No. 2012/0278211 filed by Loveland et al. discloses a system for remotely tracking and monitoring worker's activities via mobile phones or other mobile tracking devices. This system continuously monitors whether or not a worker is present at a worksite.

WO 2010/011652 filed by Manser discloses a system and method for tracking employee performance. The Manser system provides a user interface to allow the user to assess the balance of hard skills and soft skills of an employee, evaluate the employee's performance in a plurality of categories and compare the average cost for the job in the marketplace to the cost of the employee being evaluated. The system also analyzes the average cost of a similar job in the relevant marketplace during employee reviews. The program continually monitors the value of an employee to the employer to determine ROI at any given time. The system can be applied to direct hires, contractors, temps or any employee relationship. The system allows the identification of both over-achievers and under-achievers. The system provides a means by which employees may determine how to get the highest ratings via their work efforts.

EP 2338293 filed by Molotsi et al. discloses a system for time tracking for employers on a mobile computing device. The system involves providing an event manager on a mobile computing device for managing a plurality of events, which are then synchronized to a server. The system will automatically track time and estimate time spent on a task by the worker. This system logs events in the user's calendar, emails, and texts. Timestamps for events and mapping for the events are provided. A client list and data may be provided in one or more files or databases. The system may communicate with a worker's smartphone. The user may be able to open, edit, delete, review or manage all automatically created event records. The system may use information in the text, email, and calendar, to automatically create a time tracking record for the user. In addition, the system may automatically convert emails, texts, and meetings on a calendar to a time tracking event by means of a pop up box to the user.

WO 2008/061146 filed by Neveu et al. discloses a system and method for remote time collection for employee time on job sites. The system can collect an employee's name, picture, title, contact information, health and/or safety information, skill information, etc. The system can also collect for each employee a project name, project identification, location, project start date, project supervisor and detailed comments about project activity. The system can also collect information on vendors, such as name, address, phone, contacts and type of vendor. The system can also use GPS information and compare it with the time the employee is supposed to work. The system collects biometric information to identify an employee. In one embodiment, a time collection database is configured to receive, process and store information related to projects such as name, identification, location, start date, supervisor, vendor's name, address, contact number, subcontractor type, project supervisors, tasks, employee titles, departments, employee time records, etc. Office data collection may include: job site, task and project information via a wireless connection. Encryption is used to transmit data to and from the remote site. The system may also include a field scheduling module to schedule a job for a particular jobsite and for a specific remote user(s). The user can edit hours and view comments from remote workers. Remote monitoring can record task completion, view management comments and ask for management assistance and crew responsibilities.

U.S. Patent Disclosure No. 2015/0081381 filed by Okoba discloses a system and method for recording time, which may be used on a device, software or application. It may be used by logging into a plugin or extension. The time recorded may be exchanged for vouchers, which may be redeemed or traded with other members. A user will register with an ID and password to log into the system. The system may record device activity, software activity, application activity, keyboard activity and mouse activity. The user's time spent in the browser or on a video game may be given a redeemable value. A database may store the recorded activity for further analysis. The system will work on computers, tablets, cell phones, television, games, digital books, exercise apparatus, web browsers, mobile apps and video games. Vouchers may represent monetary value, promotions, products or services. User name and password may be stored in system cookies. The system can capture video game or browser activities, as well as keyboard or mobile keyboard activities. The activity spent in the system may translate to purchasing power so that the user may receive optimized value from their activities and the system may deliver purchasing incentives at the right time and place and for the right product or service. A business may be selected as a favorite from user activity on the system.

U.S. Patent Disclosure No. 2015/0081487 filed by Porter, et al., discloses the use of a time tracking and productivity system including a tracking component to locate an employee to record time spent at various locations. This system is designed to monitor and improve coordination of patient care, and in particular, to limit the number of patient hours a resident physician can work per week. When the rules implemented by the ACGME are violated, strict fines and probations or suspension may be implemented. This system is primarily concerned with tracking an employee's location and work hours. This system can include cloud performance. It is the movement of an employee within predetermined boundaries that will trigger the recording of a new event. It can track time in a patient's room, a brake area, doing paperwork, etc. A GUI is used on handheld devices. The system can also use tags that interact with RF signals. The system records employee info and FRIDA numbers, the resident program director, the resident coordinator, start and end times for resident shifts, house calls, in house calls, night float, etc. If moonlighting is permitted, the system can track moonlighting hours as well. It will store vacation schedules and rotation schedules. The shift log can include a short trip buffer. Automatic warnings of over limit hours are sent to management for the residents via text, phone, email, etc.

U.S. Pat. No. 6,185,514 issued to Skinner, et al. discloses a method and system for automatically collecting and analyzing information regarding time and work performed on a computer. It uses a data collector for monitoring certain portions of a worker's computer activity and an analyzer for showing which portions of the activity were continuous work activities, and the system will categorize the work into preset projects and tasks within a project. The information is periodically written to data storage. The system is directed toward telecommuters. The system automatically excludes time where there was no activity on a computer. The system is used to forecast future projects with reduced financial risk. The system includes the automatic documentation of time. The data stored on the system is encrypted so that it cannot be altered by the user. The data collector automatically collects the activity on a mouse and on the keyboard of the computer user. The system creates a log file of work activity. A hardware abstraction layer can interface with phones and other devices and can be used with pointing devices such as a tablet or mouse. The system keeps track of activities within open multiple windows on a computer.

U.S. Pat. No. 8,209,243 issued to Smith, et al., discloses the use of a system for performing real time labor management and timesheet reporting which is adapted to wirelessly transmit timesheet information. The portable devices may be dedicated to tracking time only and cannot perform other computing functions. The system includes a portable electronic punch system that is capable of communicating with the labor management system via text. The system allows the user to manage work schedules and report timesheet information without requiring an Internet accessible computer. The units send timesheet information directly back to the server for analysis via wireless network. The text messages may contain: employee ID, clock in time, clock out time, break times, days worked, days off and other work related information. New user information may be set up by text message into the timekeeping system. The system may operate over any wireless system, i.e., GSM, GPRS, CDCP, Bluetooth, Wi-Fi, etc.

U.S. Pat. No. 9,020,848 issued to Ridge, et al., discloses the use of a method for tracking time and location of an employee according to a predefined schedule and it may utilize software to track the presence or non presence of: a NFC (near field communication), BLE (Bluetooth Low Energy) or other wireless device. The system will track the presence of an employee in a geo-fenced area. It will also track employee time and other data to log that into a payroll system. The low energy device then communicates data to a server if a signal could or could not be detected. It will also allow for manual clocking in and out in case of failure of the back end server. The system can also be used for security purposes. The system can function in real time or in batch request mode. The information may be a time stamp, a status or location of a mobile device. In one embodiment, the system can be used for employees for a retail store or restaurant. The system can utilize Bluetooth tapping to log in. It may be used at a trade fair both by tapping the device to a NFC communicator. It may be used in connection with a mobile time clock app. It can be used to advise management when non-authorized employees enter a restricted work zone. Management may input which work zones are restricted and which are not.

WO Disclosure 2015/029073 filed by Shirish discloses a system and method to measure aggregate and analyze exact effort and time productivity by reviewing time spent on activities such as calls, travel, lab work, meetings, discussions and remote visits. Presence Devices (PD) may be used to track employee location. The system can track average daily work patterns. It can track work activities and private activities. It can track emails and browsing. It can account for flexible work hours, use of multiple and different types of computing environments (PC at work and home, smartphones, tablets, etc.) It can capture files, folders, web links, etc. It can make all personal endeavors password protected and private. It is intended to track effort and performance 24/7. It can provide modules that promote work focus and minimize distraction by awarding performance points, badges for consistent performance and progress in performance goals. It can measure improvement by creating an n-dimensional effort data cube and include analytics for custom reports. The system can go into self-improvement mode to set goals for self improvement and activities related thereto. It can be used at work whenever and where ever. It has a time tracker for all online time. It has a merger to merge offline and online time effort mapping. It has an interference engine to determine work patterns for employees, leave taken, work done on holidays, desk or supervisory or travel oriented job, etc. The system will also present organization goals and analytics, top performers, work patterns, and recent deviations from work patterns. A collector module measures data to improve the exact work effort at the individual level throughout the day. The system can be used on SAS (Software as a Service) and it may be hosted in a cloud-computing environment.

U.S. Pat. No. 2012/0173297 disclosed by Van Styn, et al., a method and system for task tracking and allocation is disclosed. The disclosure provides for a method in which an individual may create a set of instructions operable to perform a set of tasks in a computer readable medium. That set of tasks may comprise maintaining a database, generating a first interface displaying subjects associated with individual issues, and a second interface with notes specific to an issue selected by a user. The instructions stored in the database may be implemented accordingly and the computer may maintain a plurality of relationship records containing data indicating relationships across folders. The disclosure also mentions the prior use of MS Project and ERP systems that employ Gantt charts, milestones and tasks and subtasks with complex dependencies. This system keeps track of billable items. However, Van Styn is not a true timekeeping and professional billing system.

US Pat. No. 2014/0108644 disclosed by Zaents, et al., a method and system for tracking time in a web-based environment is disclosed. The method of tracking time involves a web-based application to track time associated with several records.

Identifying a record in an active state, generating a record associated with the active record and activating a timer, and having the ability to end the session in response to an indication that the record is an inactive state. The time-tracker may be hosted in a cloud-computing environment. The time-tracker may calculate the entire duration of the record by continuously adding the active times together. The method may detect a predetermined total duration of time that has been exceeded and provide such indication to user. This disclosure mentions timekeeping, billing and using a web browser and multiple tabs to record time for multiple clients when a professional is switching back and forth between projects. It is useful for billing, accounting, and auditing. More than one user can log into the system and track time-her or his time on the same computer. It also teaches the use of sub-tabs to track time. A stopwatch type button is used to switch on and off the time tracking, or time is tracked as the user switches browser windows.

However, none of the above patent disclosures teach or suggest improved billing and timekeeping systems which are able to accurately predict budgets and cash flows in a company or firm based upon statistical and mathematical predictors which analyze collections patterns and practices.

### SUMMARY OF THE INVENTION

The present invention develops local office budgets for fees and expenses. The invention supports global budgets for global and regional expenses, which are referred to collectively as the budget of the firm costs, and it supports capital expense budgets at both global and local offices. Local office must include their share of the budget of firm costs as part of their total fee and expenses budgets.

The budget process starts in December for the following fiscal year. Of course, other prior 12-month periods may be chosen, based upon the close of fiscal year for the company or firm using the System and Method for Budgeting and Cash Flow Forecasting. Standard templates are used to accommodate budgets.

The local practice groups determine fee budgets by estimating billable hours for each timekeeper and multiplying by the budgeted standard billing rate. Expense budgets are prepared based on anticipated headcount and merit increases, planned travel and planned fixed costs such as depreciation, rent, etc. The budget for the firm cost is a zero-based budget. The budgets from local offices roll up to a formula unit, region and then into firm budgets. Regional management approves local office budgets, and global firm management approves both the office budgets and the firm budget of costs.

The budget starts with an accounting or enterprise resource planning (ERP) cash flow forecast report by company code which includes all items pertaining to cash position (bank accounts) as well as the predicted cash flow (timekeeper collections) and other assets on hand (securities, bonds, etc.) Major items of consideration are: 1) bank balance; 2) future operating income; 3) future expenses; 4) staff compensation, payroll and taxes (including VAT and sales tax and payroll taxes); and 5) other major expenses (partner draws, bonuses, and distributions); 6) fixed asset expenditures (copiers, printers, furniture, etc.); 7) any inter-company transfers of assets or cash; and 8) write-offs and markdowns by client company failures and bankruptcies during the fiscal year. For many firms, 40% of all collections are made in the last month of the fiscal year. These items should be displayable electronically in the local currency as well as US Dollars.

After accounting for all the income, and subtracting any anticipated expenses, any surplus can easily be rolled up to senior management of the company or firm for distribution on a non-contractual surplus basis. In many firms, this is the senior managers and senior partners who have distribution that are non-contractual in nature. If there is a shortage, this is sent to financial operations to determine if they can cut expenditures, re-run the budget, or if it is necessary to boost financing, reduce bonuses and local profit distributions to cover the increased cost of financing the local office during a period of predicted deficit. Once all of the budgets for local offices have been run, and then the local office budgets and forecasts are rolled up into a regional budget forecast and then into the final company or firm global budget forecast.

Budget reporting occurs monthly and compares actual results to the predicted budget. Forecasts are prepared annually for purposes of a combined firm review, but local offices can prepare more frequent forecasts, according to their local needs.

The present invention includes the following budget capabilities: the ability to budget by SIO (Statistical Internal Order); budget by administrative department (finance, library, HR, etc.); timekeeper budget; ability to show multiple budgets in multiple currencies for reporting on global local offices; budget for billing lag and collection lag; budget adjustments for local working days of the national calendar; budget by % billable hours vs. collectable hours; ability to add new hires to budget and remove terminations; ability to add notes and comments to budgets to local offices and make comments mandatory; ability to phase fees, expenses, and timekeeper headcount using straight line or monthly assignments based on percentages across all periods; ability to calculate permissible depreciation for a base period based upon status of capital assets and use a predictor for estimated disposals and acquisitions for the upcoming year; ability to budget staff compensation at both the account level and at the department level, budget salary for timekeepers at individual, department and local office levels; ability to apply security when budgeting may detail individual salary levels; ability to apply security efforts by employee ID, job title and job level.

The System also has the ability to assign annual target productivity for certain timekeepers: e.g., 1650 hours per year for each active, full-time timekeeper, limit costs per timekeeper based upon title and practice group of each timekeeper. The System may have multiple budget owners to input the budget. The System can allocate expenses to cost centers and timekeepers, using headcount, rent per square foot, number of computers, printers, and use of resources (Westlaw, Lexus/Nexis, online databases, etc.). The System may be set up in a spreadsheet, .csv file, or other formats. The System may have multiple versions (i.e. Initial Budget, Budget Round 2, Budget Round 3, etc.) after global allocations and regional allocations are developed. The System can account for different timelines for the local and global budget. The System can generate reports for prior year versus the current year, a year-to-date budget and actual data available in a template during the budget development process.

In addition, an audit trial to all versions of the budget is provided. The System must budget for all capital asset expenditures during each year. The System must compensate for variations in which compensation is paid at each local office. The System must create a custom financial plan template, which allows for calculating past years, as well as the present and future years of budgeting.

The present inventive system may analyze budgets for: office, legal entity, region, formula unit, firm, timekeeper, local practice group, global practice group, and regional practice group. The budget must be able to show forecasts on a monthly and annual basis at the local and regional levels.

The System is able to capture notes, comments and “what if” scenarios that each forecast is based upon. The System is able to cover the current year and three years past years in US Dollars and other currencies where local and regional offices are located. The System is able to generate, for each year, past, current and future, a balance sheet and profit and loss system for the firm or company involved. The System is also able to show historical trends such as billable rates by practice groups and related realizations by timekeeper, local and regional practice groups and practices.

Reports may be distributed to firm management and partners electronically by MS Word, Excel, PDF and in other formats as requested by firm management and partners entitled to view budgets and budget forecasting. The expenditures of cost centers must be calculated from prior years and predicted for the current fiscal year and into future years, for budgeting purposes. It may be necessary to pull in accounts and firm compensation from other types of databases (i.e. Excel or SQL) in order to develop the global budget for the firm.

The System can be performed in any local currency, and that currency can be then be displayed in U.S. Dollars, or any other currency, as desired, and the System will check automatically and in real time or near real time with online exchange rates which are typically published in the New York Times, Wall Street Journal, Washington Post, etc. The System may calculate overhead (staff salaries, SIO or cost centers, interest on operating lines of credit, cost of doing business supplies, paper, copier, fax, phone, etc.) at the timekeeper level, local practice group level, and according to the local, regional, or global office. The System may also create budget forecasts, which are used for custom financial plans. A budget planner who enters historical data into the system or imports it from an accounting program or programs initiates the System. The financial planner to make accurate predictions for the upcoming months and fiscal year may then adjust this data. An operational support finance team can be used to post journal adjustments either manually or via electronic means (ERP or an accounting program) to adjust for changes in the financing available to the Local Firm local firm. Once that is accomplished, the actual budget can be prepared for upcoming months and the fiscal year at year's end. The budget and forecasting may then be distributed manually or electronically, in any format desired (Excel, Word, PDF) and it may be distributed only to select individuals (managing staff on a need-to-know basis, and partners), with or without password protection on the files. In firms where employees all have their own accounts, it can simply be posted in the partner accounts, or it can be posted at a password secure website).

With the present invention, partners and others may review the budget and cash flow, and then contact companies and vendors to conduct comparative bidding and ask for further discounts for the firm or company. If these benefits are realized, then a portion of the cost savings may be split with the partner at year-end in the form of a dividend, distribution or profit-sharing.

In such a manner, partners will know and be able to adhere to their budgets on both soft costs and hard costs, they can be updated monthly on each budget item to keep their budget in line each month, and ensure controls over what the staff and timekeepers are spending in order to do their jobs effectively. The amount of cash on hand, and the outflow of monthly expenditures are crucial to the survival of any organization. If costs are not contained properly, the firm or company must then dig deeper into its operations credit line, which can be very costly. When rents and vendors are not paid, the firm or company is at a huge risk for involuntary dissolution and bankruptcy. This must be avoided at all costs by reigning tight administrative control over finances. The present invention encompasses numerous features and advantages over the prior art to spot troublesome areas quickly and correct them promptly before the firm or company's finances become a threat to the survival of the business.

It should be observed that there are numerous configurations, adaptations, options, additions and rearrangements of elements found in the prior art which are considered obvious to try and which should be considered as part of the summary of the present invention as if fully set forth herein.

### OBJECTS OF THE INVENTION

Thus, it is one primary object of the present invention to provide a system and method for budgeting and cash flow forecasting by listing all income categories, then listing all expenditure categories and then taking the difference to produce a report for end of year income surplus or deficit, then electronically analyze the distribution from month 1 to month 12 and use the analysis to predict cash flow for the ensuing fiscal year on a month-by-month basis in one or more currencies as calculated on one or more internet website reporting on same.

It is yet another primary object of the present invention to provide a system and method for budgeting and cash flow forecasting to provide each partner or manager with an online account for a company or firm, and then distribute predicted monthly cash flow together with all updates on the online account, or direct the User of the online account to a secure website where the current budgets and cash flow forecast for the month is predicted which has been secured with a password.

It is still a another primary object of the present invention to provide a system and method for budgeting and cash flow forecasting to provide a system which will automatically calculate and tally taxes on payroll, sales tax and VAT midyear to produce a monthly budget forecast for management planning purposes, by automatically downloading tax tables mid-year.

A further primary object of the present invention is to provide a system and method for budgeting and cash flow forecasting to provide cash flow estimates by calculating the cost of any debt load upon operations by downloading interest rates for these credit lines which are generally linked to online sources such as treasury bills, LIBOR and the like, calculating the debt load and its effect upon monthly cash flow to a company or firm.

It is yet an additional primary object of the present invention to provide a system and method for budgeting and cash flow forecasting to allow partners to suggest and implement cost savings to a firm or company, recalculate the budget and then share a portion of the cost savings to the partner in the form of a dividend, distribution or year end bonus.

Still another primary object of the present invention to provide an improved system and method for producing budgeting and cash flow forecasting to provide for a local company or firm a means to list all cash flow incoming items, and all expense items for the company, and predict the surplus or shortage for the company, which is then rolled up with other local companies or firms into a budget and cash flow forecast for a global company or firm having multiple local, regional, or national offices so that the global company or firm may determine if there will be a surplus which may be distributed to senior partners or management eligible to share in taking the surplus at year-end in the form of a distribution, dividend, or profit-sharing.

Yet a further primary object of the present invention to provide an to provide an efficient and accurate System wherein financial planners can increase a credit line or operating capital account to cover periods of deficit with the most optimal funding during the year by having time to plan in advance and study financial institutions offering the most favorable interest rates.

It is still a primary object of the present invention to provide a system and method for budgeting and cash flow forecasting such that when cash flow is low or the firm or company is running at a deficit, payment incentives may be offered to clients and customers (i.e. pay immediately with discount, sign payment arrangement with interest and payment immediately, discount for prepayment on current work, discount for payment of flat fee for work in advance, etc.).

It is an additional primary object of the present invention to provide a system and method for budgeting and cash flow forecasting to provide all budget and cash flow data, which may be protected from disclosure to unauthorized persons by providing: security by job title, name or job level.

It is yet a further primary object of the present invention to provide a method for budgeting and cash flow forecasting, which may adjust cash flow and its forecast as timekeepers and staff leave the company or as new employees are hired.

These and other objects and advantages of the present invention can be readily derived from the following detailed description of the drawings taken in conjunction with the accompanying drawings present herein and should be considered within the overall scope of the invention.

### BRIEF DESCRIPTION OF THE DRAWINGS

FIG. 1 illustrates the process flow of a system that is the embodiment of the present invention.

FIG. 2 illustrates an example of a client budget matter and a close-up of the local standard hours.

FIG. 3 illustrates a screenshot of the standard hours template according to job title.

FIG. 4 illustrates the embodiment of FIG. 3 with a pop-up screen that allows the user to send 5 data records.

FIG. 5 illustrates the embodiment of FIG. 4 with a pop-up screen that allows the user to save the data records.

FIG. 6 illustrates a screenshot of the standard hours template with a list of rates billed, a save data icon, and two drop down menus.

FIG. 7 Illustrates the embodiment of FIG. 6 with a pop-up screen that allows the user to send 5 data records.

FIG. 8 illustrates the embodiment of FIG. 7 with a pop-up screen that allows the user to save the data records.

FIG. 9 Illustrates a screenshot of the working days by title template with a list of job titles and a row of months worked, as well as a pop up screen to save results.

FIG. 10 illustrates a screen shot of the local office consolidated master input template.

FIG. 11 illustrates a screenshot of a timekeeper worksheet.

FIG. 12 illustrates the embodiment of FIG. 11 with a pop-up screen that allows the user to run a package.

FIG. 13 illustrates the embodiment of FIG. 11 with a list of timekeepers, list of job titles for each timekeeper, the company ID, and a row of months for the proposed budget.

FIG. 14 illustrates the embodiment of FIG. 13 with a pop-up screen that allows the user to run a package.

FIG. 15 illustrates a screenshot of a timekeeper direct expenses template.

FIG. 16 illustrates a screenshot of a consolidated fee income template.

FIG. 17 illustrates the embodiment of FIG. 16 with a row for collections before adjustments, collections after adjustments, and a row for other adjustments.

FIG. 18 illustrates the embodiment of FIG. 16 with selections for collections based on a monthly basis and allocation percentages for each month.

FIG. 19 illustrates a template for consolidated budget and fee expense for a plurality of accounts.

FIG. 20 illustrates the embodiment of FIG. 19 with the row “Secretarial Compensation” highlighted as an example.

FIG. 21 illustrates the embodiment of FIG. 19 with the row “Administrative Compensation” highlighted as an example.

FIG. 22 illustrates the embodiment of FIG. 19 with the row “Marketing Compensation” highlighted as an example.

### DETAILED DESCRIPTION OF THE DRAWINGS

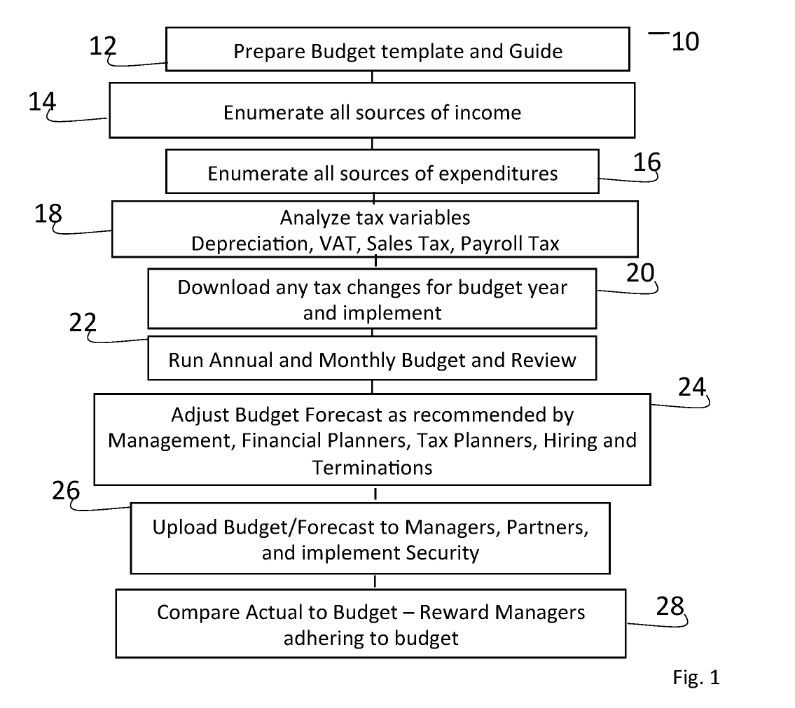

FIG. 1 illustrates flow chart of the present invention System and Method for Budgeting and Cash Flow Forecasting 10 demonstrating the process for implementing, approving, running and distributing budget and cash flow predictions in a secure environment. The first step in preparing a budget and cash flow analysis for an upcoming period of time is to prepare a budget template and a set of rules and guidelines 12, which is then populated electronically from historical data from the previous fiscal year. Income categories 14 are selected first and generally consist of: payments from clients and customers, income from investments, income from rentals, income from counsel members of the firm, and all other sources of revenue. Next, the expense categories 16 are populated from the historical data and will consist of the following usual categories: rent, salaries, dividends, distributions, interest on operating line of credit, etc. After the expense categories are populated, the hard and soft costs for equipment, furnishings, fixtures, supplies, etc. are added in. These income and expenses are analyzed by month and then the difference between the two is the cash flow. Bank account balances for operating capital at all times are considered for months in which cash flow is either low or running at a deficit. For the months in which cash flow is low or at a deficit, the interest expected to pay is added. These months may be flagged so that financial planners may shop for the best interest rates for operating capital for the firm or company.

The next step is to analyze tax variables 18 from expenses or phantom income from taxes, which are expected to occur from sources such as depreciation (phantom income), VAT, regional or state sales tax and payroll taxes. Since these taxes may change over the upcoming months or year, the System will perform periodic checks of relevant tax tables 20 from the various government authorities to keep tax expenditures accurate and up to date by downloading the tax tables as they occur or are published. In addition, the System will then generate annual and monthly budget data for information and review 22 by authorized partners, corporate officers, and management. This information may be published in employee online accounts for employees that either have access to the information on a need to know basis, or employees and managers who have a right to know the corporate financial information, budgets and cash flow. At this point, managers and partners may suggest and implement critical changes to the budget forecast 24 to make it more accurate. Persons who are most adept at making suggested changes to the budget forecast are generally: managers, corporate officers, financial planners, CPA's, tax planners, and human resources, who are given information such as new hires and new terminations at or near the time they occur. As adjustments to hiring, salary, and work level (i.e. full time to part time or vice versa) occur, human resources may send the data to the office of budgeting to enter it into the budget and cash flow system and run periodic updates on monthly cash flow and budgets.

After the budget and cash flow data has been agreed upon, security is assessed 26 as to which employees are authorized to view the data. Security may be authorized by employee name or ID, and/or job title or level.

Finally, the budget and cash flow analysis 28 is run and distributed to key personnel. Those departments that adhere to the budget and cash flow analysis for the upcoming year are rewarded for their performance and discipline, while departments, which are over budget, are put under management scrutiny and are assisted in making financial decisions and plans.

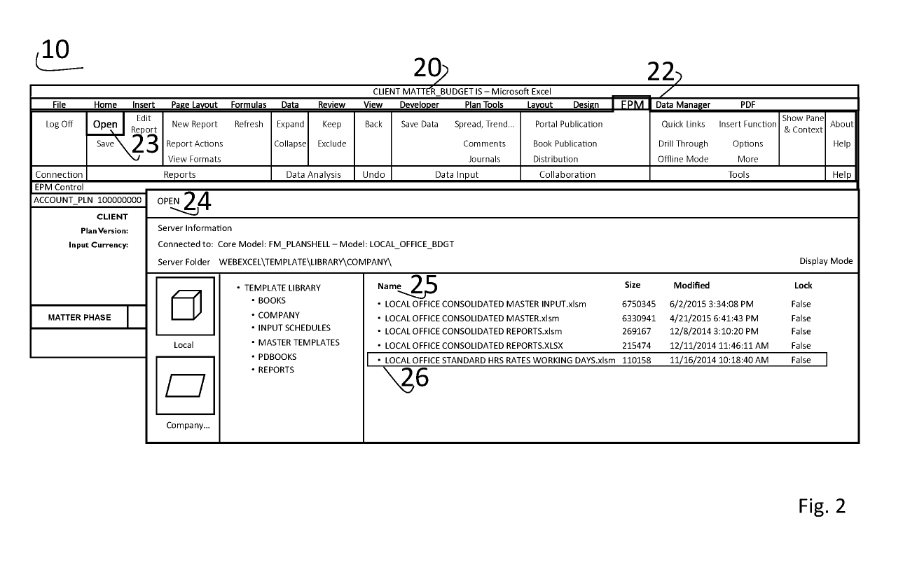

FIG. 2 illustrates the System and Method for Budgeting and Cash Flow Forecasting 10 template having the header: “Client Matter Budget” 21, enterprise performance management (EPM) tab 22, which the user clicks on next, open file icon 23, which brings up Open pop up box 24, name list 25, and the individual file “Local Office Standard Hrs. Rates Working Days” 26, which is an Excel spreadsheet file format .xls.

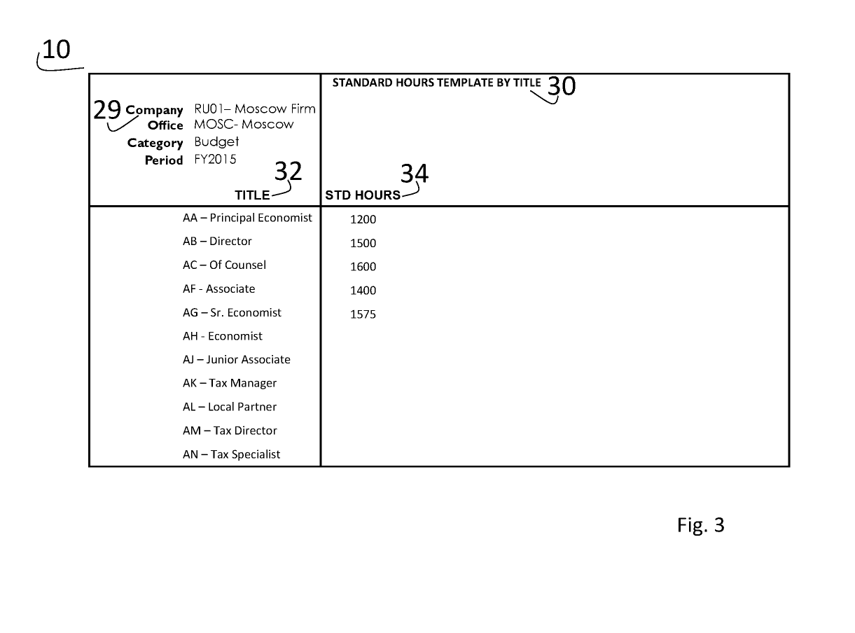

FIG. 3 illustrates the system and method for budgeting and cash flow forecasting 10 template having company ID 29, title “Standard Hrs. Template by Title” 30, job title list 32 and a list of standard hours 34.

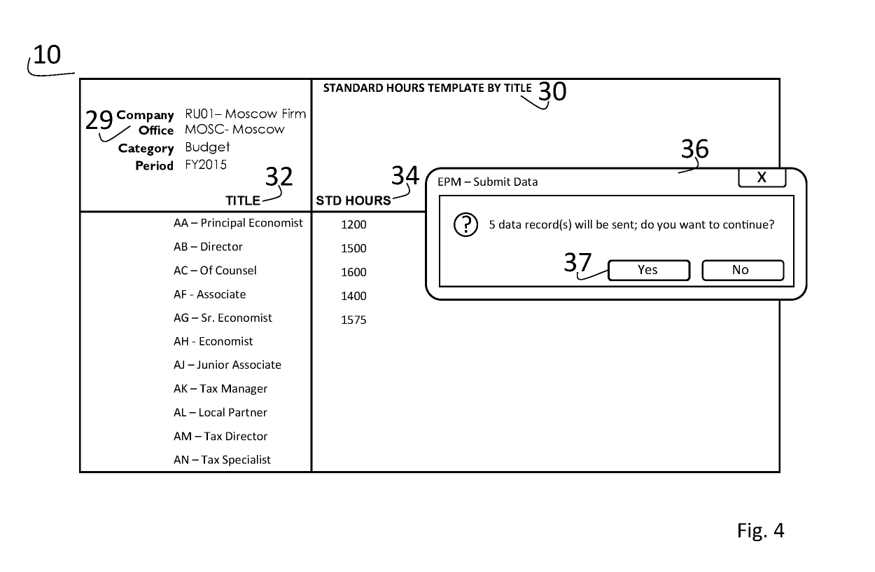

FIG. 4 illustrates the system and method for budgeting and cash flow forecasting 10 template having company ID 29, title “Standard Hrs. Template by Title” 30, job title list 32, a list of standard hours 34, pop out save results box 22a, close button 36, and yes button 37 to send 5 data records.

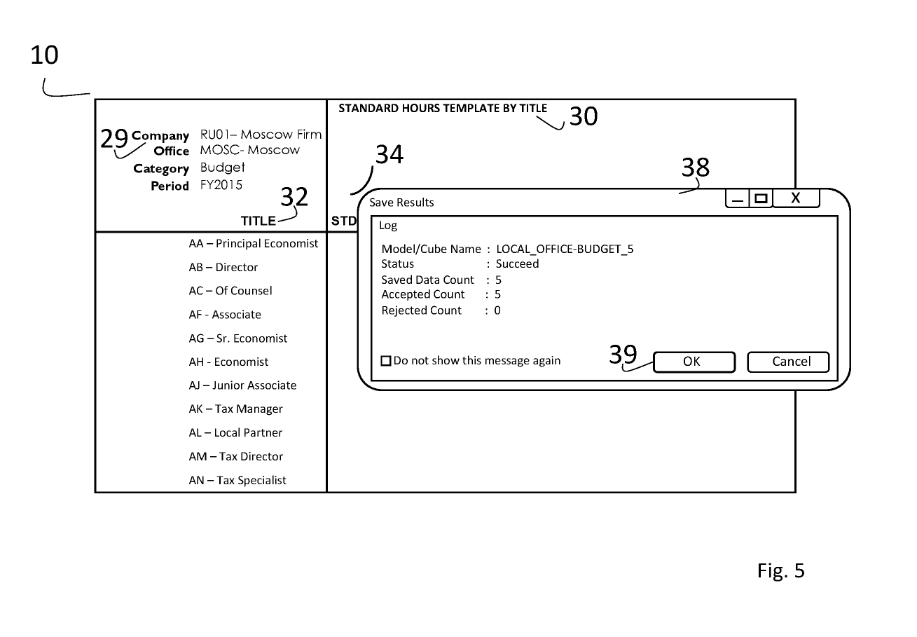

FIG. 5 illustrates the system and method for budgeting and cash flow forecasting 10 template having company ID 29, title “Standard Hrs. Template by Title” 30, job title list 32, a list of standard hours 34, a pop out save results box 38 and an OK to save icon 39.

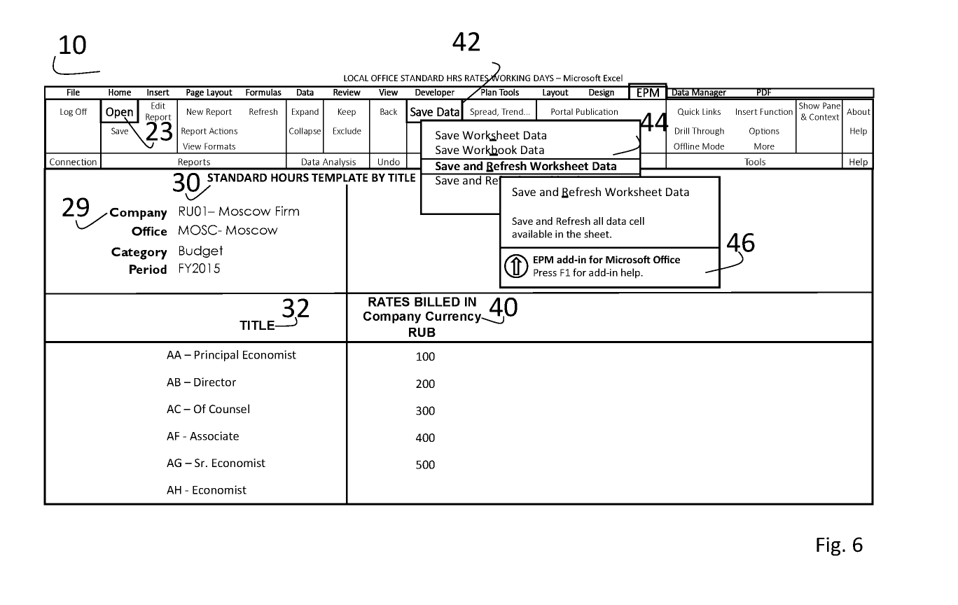

FIG. 6 illustrates the system and method for budgeting and cash flow forecasting 10 template having company ID 29, title “Standard Hrs. Template by Title” 30, job title list 32, a list of rates billed 40, save data icon 42, a drop down menu 44, and a second drop down menu 46.

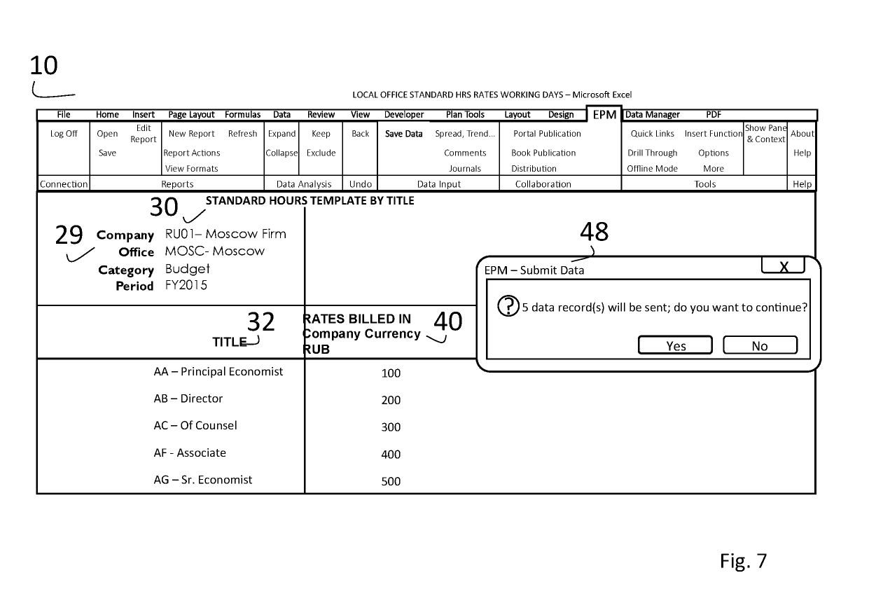

FIG. 7 illustrates the system and method for budgeting and cash flow forecasting 10 template having company ID 29, title “Standard Hrs. Template by Title” 30, job title list 32, a list of rates billed 40, and a pop out box 48 asking the user to save 5 data records.

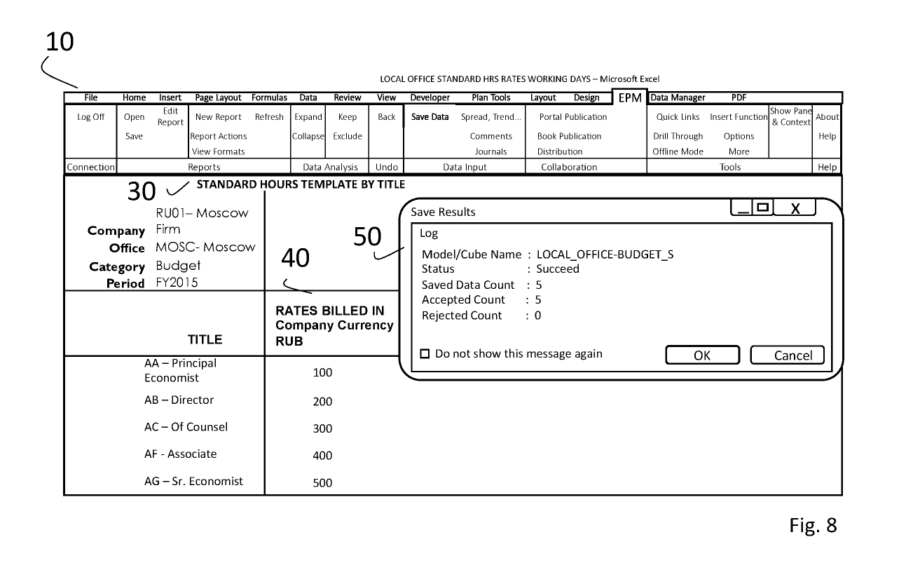

FIG. 8 illustrates the system and method for budgeting and cash flow forecasting 10 template having title “Standard Hrs. Template by Title” 30, a list of rates billed 40, and pop out box 50 indicating the saved results.

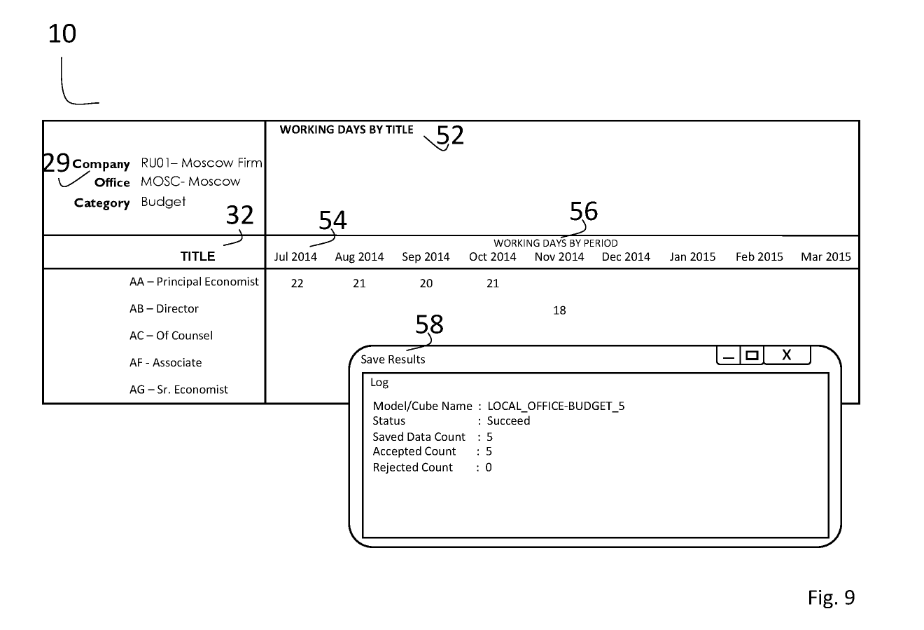

FIG. 9 illustrates the system and method for budgeting and cash flow forecasting 10 template having the title “Working Days by Title” 52, a series of columns for each month for working days 54, company ID 29, job title list 32, a “Working Days by Period” header 56, and a pop out box 58 to save the results in the report.

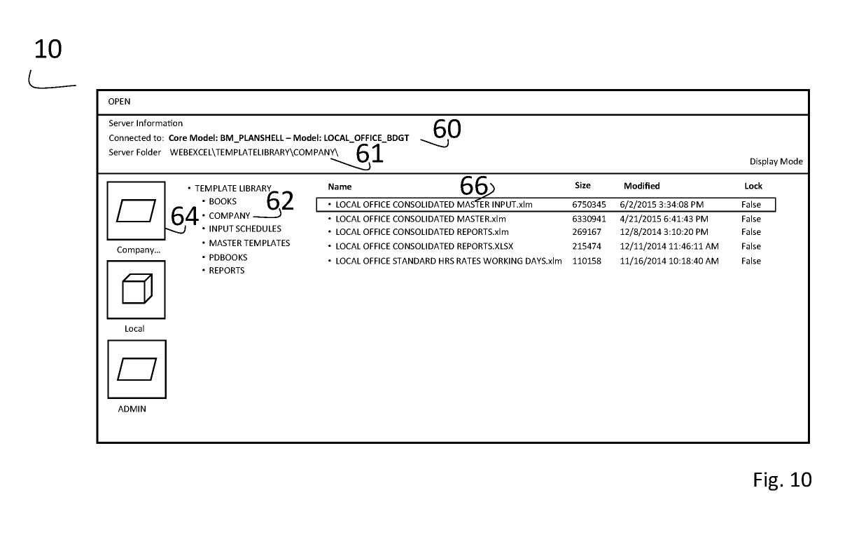

FIG. 10 illustrates the system and method for budgeting and cash flow forecasting 10 template showing the header “Core Model BM PLANSHELL model Local Office Budget” 60, the Server Folder 61, the directory tree 62 showing “Company”, where the “Local Office Consolidated Master Input.xlm” template 66 is located, and the company icon 64.

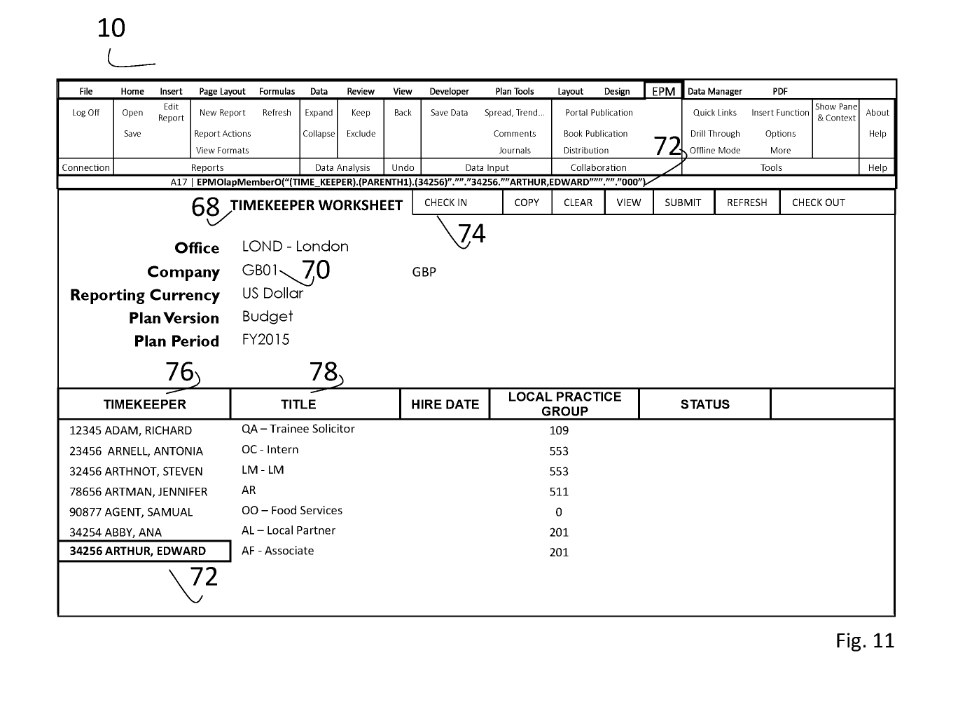

FIG. 11 illustrates the system and method for budgeting and cash flow forecasting 10 template having the title “Timekeeper Worksheet” 68 with formula header in “A17” 72, timekeeper list 76, and job title list 78 for each timekeeper and the ID 70.

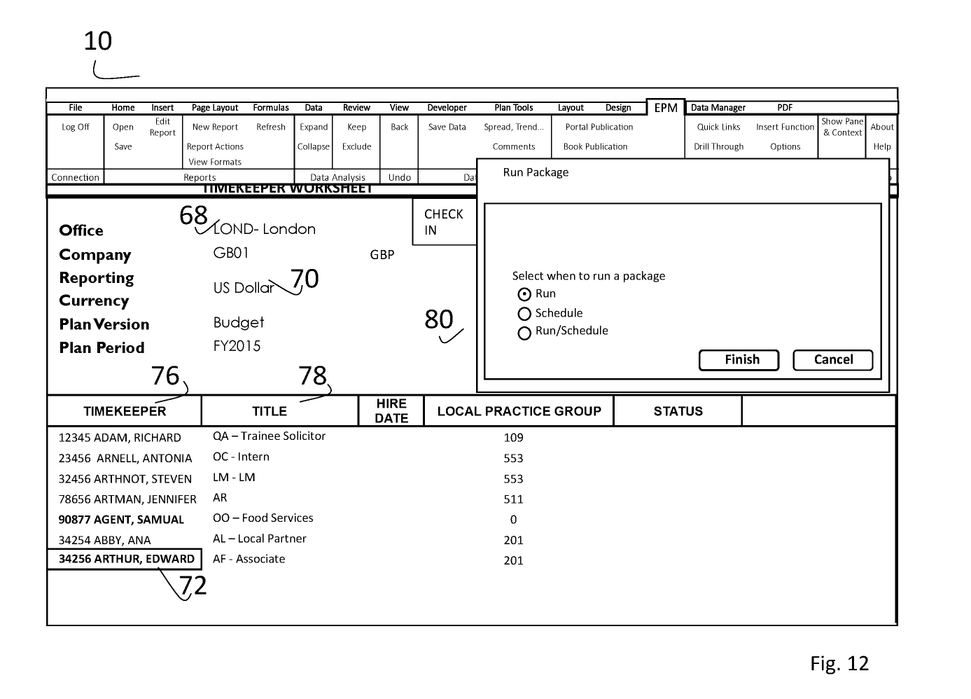

FIG. 12 illustrates the system and method for budgeting and cash flow forecasting 10 template having the title “Timekeeper Worksheet” 68, with a timekeeper list 76, job title list 78 for each timekeeper and the ID 70 and a pop out box 80 for running figures.

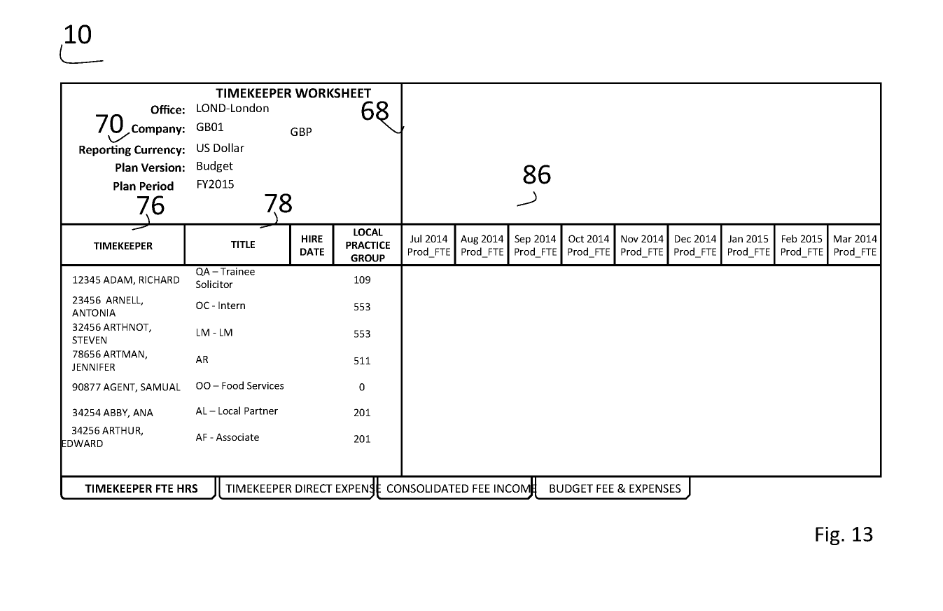

FIG. 13 illustrates the system and method for budgeting and cash flow forecasting 10 template having the title “Timekeeper Worksheet” 68, with a timekeeper list 76, job title list 78 for each timekeeper and the ID 70 and a row of months 86 for running the proposed budget.

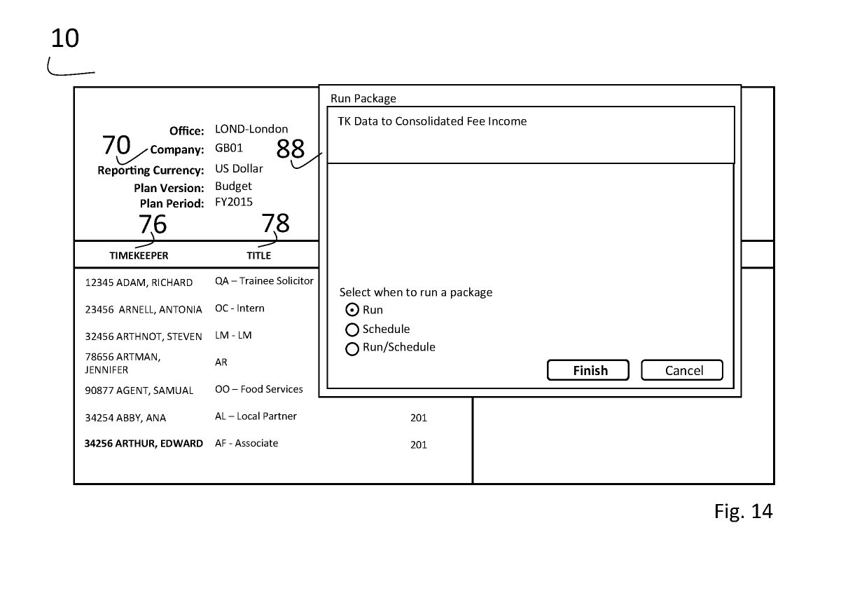

FIG. 14 illustrates the system and method for budgeting and cash flow forecasting 10 template with a timekeeper list 76, job title list 78 for each timekeeper and the ID 70 and a pop out box 88 to run the package.

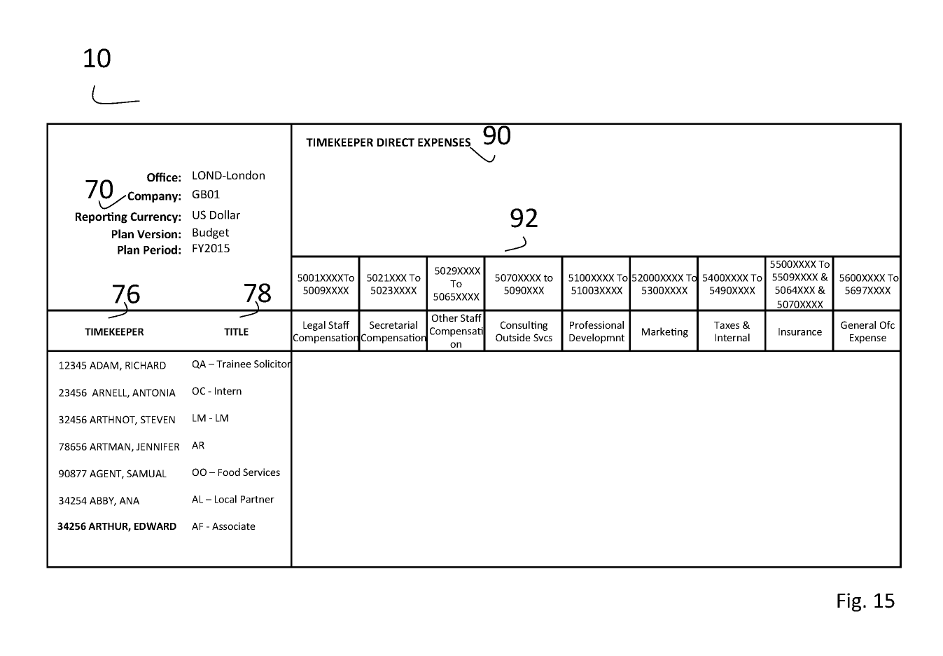

FIG. 15 illustrates the system and method for budgeting and cash flow forecasting 10 template having the title “Timekeeper Direct Expenses” 90 with a company ID 70, a timekeeper list 76, job title list 78 and a row of Accounting Categories 92 for this Template.

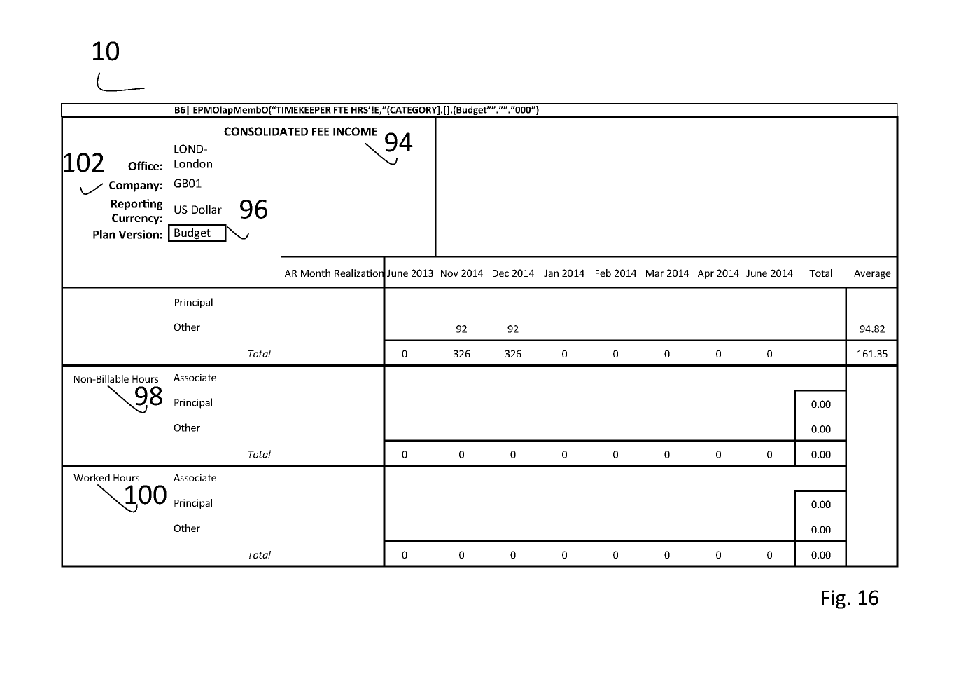

FIG. 16 illustrates the system and method for budgeting and cash flow forecasting 10 template with a company ID 102, a plan version budget 96, a title of “Consolidated Fee Income” 94, a row of non-billable hours 98, and a row of worked hours 100.

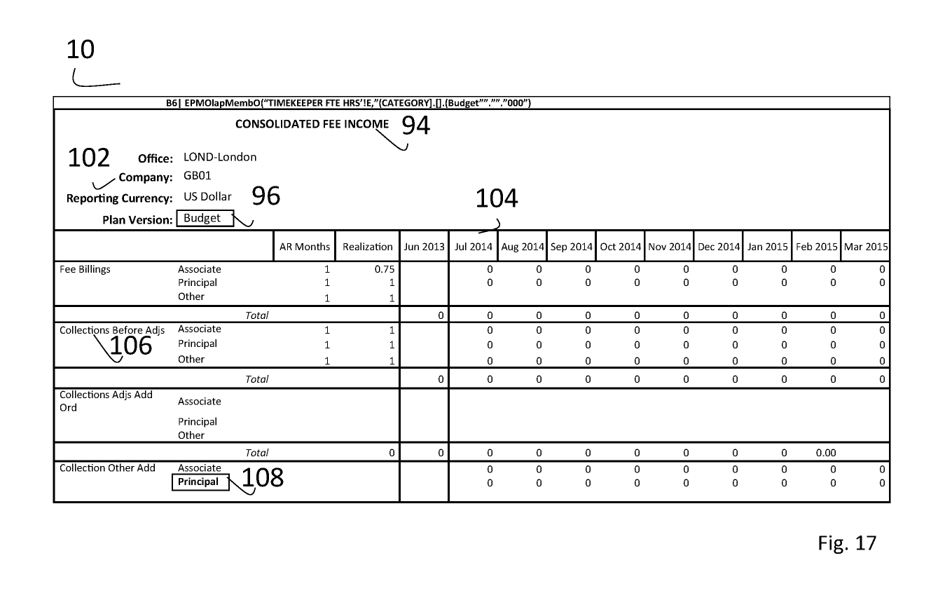

FIG. 17 illustrates the system and method for budgeting and cash flow forecasting 10 template with a company ID 102, a plan version budget 96, title of “Consolidated Fee Income” 94, a Budgeting Months row of budgeting months 104, a row of collections before adjustment 106, and a row of other adjustments 108.

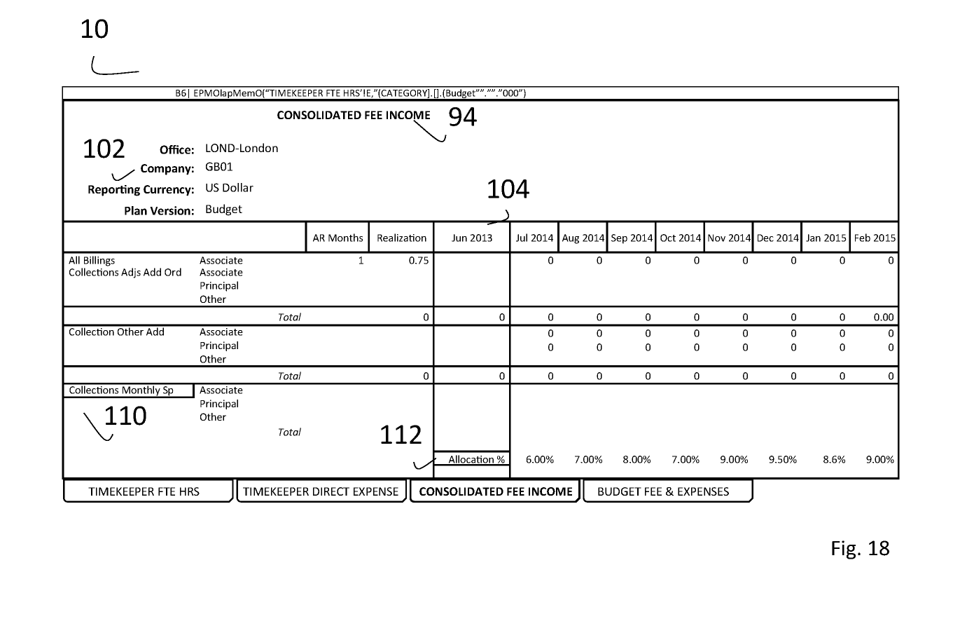

FIG. 18 illustrates the system and method for budgeting and cash flow forecasting 10 template with a company ID 102, the title “Consolidated Fee Income” 94, collections data 110, and a row of monthly allocation percentages 112.

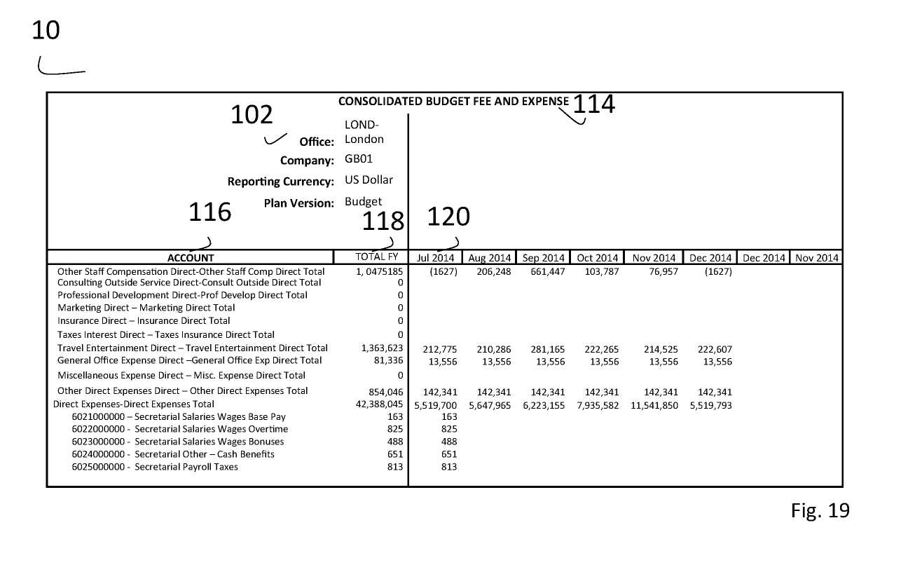

FIG. 19 illustrates the system and method for budgeting and cash flow forecasting 10 template with a company ID 102, the title “Consolidated Budget Fee and Expense” 114, a list of expenses for a plurality of accounts, a total fiscal year 118 column, and the monthly figures 120.

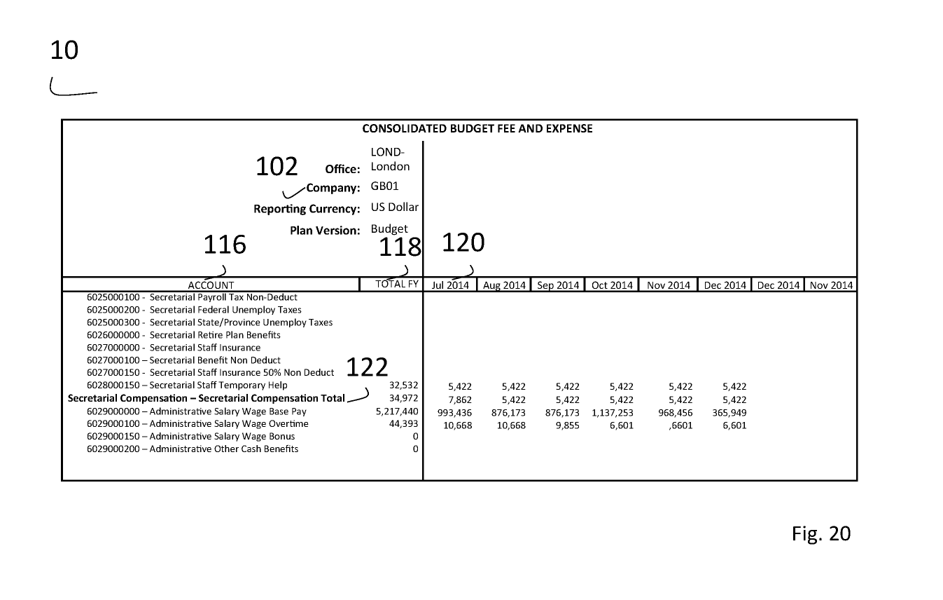

FIG. 20 illustrates the system and method for budgeting and cash flow forecasting 10 template having a list of accounts 116, an account titled “Secretarial Compensation” 122, which has been selected, total fiscal year 118 column, and monthly totals 120 for this account.

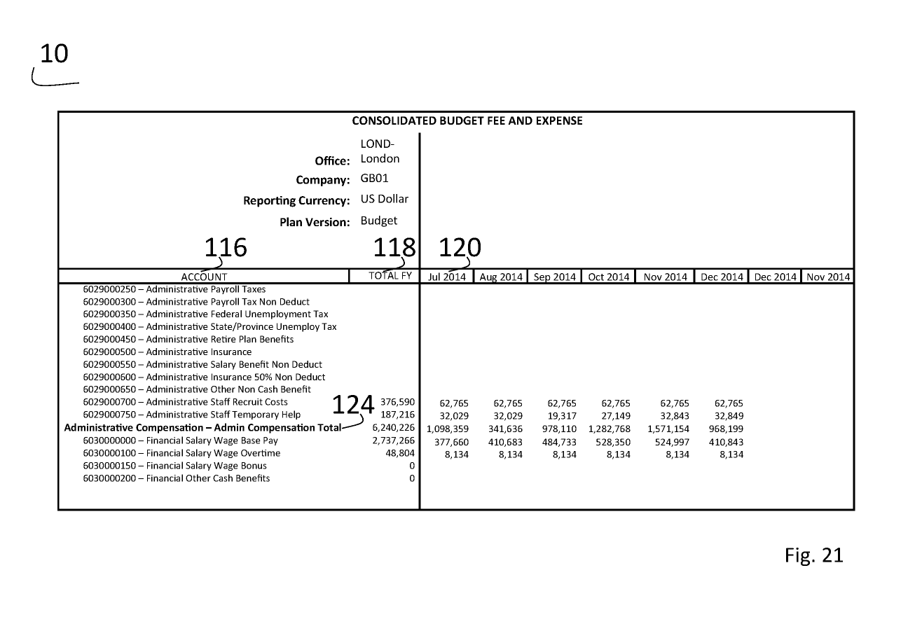

FIG. 21 illustrates the system and method for budgeting and cash flow forecasting 10 template having a list of accounts 116, an account titled “Administrative Compensation” 124, which has been selected, total fiscal year 118 column and monthly totals 120 for this account.

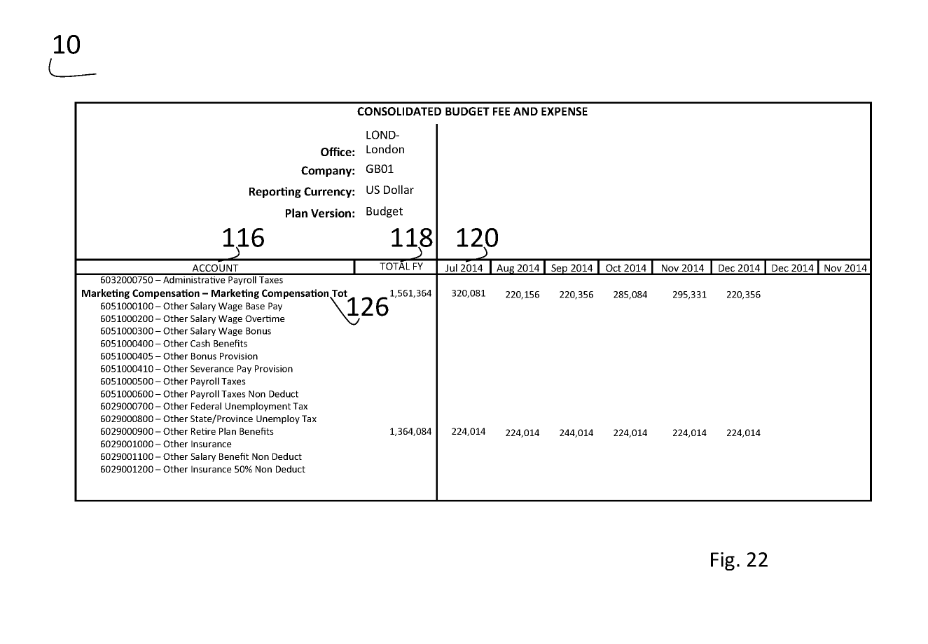

FIG. 22 illustrates the system and method for budgeting and cash flow forecasting 10 template having a list of accounts 116, an account titled “Marketing Compensation” 126, which has been selected, total fiscal year 118 column and monthly totals 120 for this account.

Although in the foregoing detailed description the present invention has been described by reference to various specific embodiments, it is to be understood that modifications and alterations in the structure and arrangement of those embodiments other than those specifically set forth herein may be achieved by those skilled in the art and that such modifications and alterations are to be considered as within the overall scope of this invention.

What is claimed is:

1. An Improved System for Budgets and Cash Flow Forecasting for a Company or Firm comprising: providing a CPU and data storage and an Electronic Display, for at least one prior Fiscal Year: Listing all Income Categories, Listing all Expense Categories, Calculating the Income and any Deficit for the prior Fiscal Year; Using the Income and Deficit Income by Category to Calculate Income for an upcoming Fiscal Year, the improvement comprising: Displaying electronically at least one of the following from the group comprising: monthly Cash Flow, Deficit Spending, Income and Expense Categories and yearly Cash Flow, Deficit spending, yearly Income and Expense Categories in at least two currencies where at least one was generated from downloading an exchange rate from an internet website providing same.

2. The improved Budget and Cash Flow Forecasting System according to claim 1 further having; an online account for each authorized employee with an ID and password where the employee is directed to an online secure website which uses the employee password to access the Display of at least one of the following: monthly Cash Flow, Deficit Spending, Income and Expense Categories and yearly Cash Flow, Deficit spending, yearly Income and Expense Categories in at least two currencies.

3. The improved Budget and Cash Flow Forecasting System according to claim 1 further having a Category of at least one of the following Tax Categories: Taxes on Payroll, Sales Taxes and VAT; wherein at least of the Tax Categories was created by accessing an online website providing current Tax tables for the Tax Category and the Budget and Cash Flow forecasting System was updated according to changes in the Tax Category and then displayed to a Company Employee.

4. The improved Budget and Cash Flow Forecasting System according to claim 1 further having Deficit Spending in one or more future months, with the System automatically displaying to the User a Revised Budget and Cash Flow analysis after downloading current information on the following and calculating a new debt load: LIBOR, Treasury Bills and COLA (Cost of Living).

5. The improved Budget and Cash Flow Forecasting System according to claim 1 further having calculated a Budget and Cash Flow analysis for an upcoming Fiscal Year for a first company, with the company having a plurality of sibling companies and a Parent Global Company, the first company combing its Budget and Cash Flow analysis with the Budgets and Cash Flow analysis of sibling corporations and rolling these together to calculate and generate a Global Budget and Cash Flow analysis for the Parent Global Company.

6. The improved Budget and Cash Flow Forecasting System according to claim 1 further having means to download competitive interest rates from a plurality of financial institutions and displaying same to the User of the System and the User being able to select the best rate from a plurality of financial institutions and apply for an operating loan during a period of time when cash flow is substantially at a low point and when cash flow is in the negative.

7. The improved Budget and Cash Flow Forecasting System according to claim 1 further having the ability to post online Budget and Cash Flow information for a Company and the System being able to provide security against unauthorized access to said information according to at least one of the following security criteria: name of employee, ID of employee, job title of employee and job level of employee.

8. The improved Budget and Cash Flow Forecasting System according to claim 1 further having the ability to revise its calculations each time an Employee leaves the Company and each time an Employee is hired by the Company.

9. The improved Budget and Cash Flow Forecasting System according to claim 1 further having means to identify when Cash Flow will be substantially low or in the negative, and the System triggering an alert to Company employees for a preselected advance period to study and implement optimal funding for the time period in which Cash Flow will be substantially low or in the negative.

10. The improved Budget and Cash Flow Forecasting System according to claim 1 further having means to offer to clients incentives to pay when Cash Flow is predicted to be substantially low or in the negative, which incentives to pay are selected from one or more of the following groups of Payment Incentives: an offer of a discount for immediate payment; an offer of a payment plan at favorable terms and interest rates, a discount for prepayment on work in progress and a discount of payment for work yet to be done and offer of a flat fee and payment in advance for work that is yet to be done.

11. An Improved Method for Budgets and Cash Flow Forecasting for a Company or Firm comprising: providing a CPU and data storage and an Electronic Display, for at least one prior Fiscal Year: Listing all Income Categories, Listing all Expense Categories, Calculating the Income and any Deficit for the prior Fiscal Year; Using the Income and Deficit Income by Category to Calculate Income for an upcoming Fiscal Year, the improvement comprising: Displaying electronically at least one of the following from the group comprising: monthly Cash Flow, Deficit Spending, Income and Expense Categories and yearly Cash Flow, Deficit spending, yearly Income and Expense Categories in at least two currencies where at least one was generated from downloading an exchange rate from an internet website providing same.

12. The improved Budget and Cash Flow Forecasting Method according to claim 11 further having; an online account for each authorized employee with an ID and password where the employee is directed to an online secure website which uses the employee password to access the Display of at least one of the following: monthly Cash Flow, Deficit Spending, Income and Expense Categories and yearly Cash Flow, Deficit spending, yearly Income and Expense Categories in at least two currencies.

13. The improved Budget and Cash Flow Forecasting Method according to claim 11 further having a Category of at least one of the following Tax Categories: Taxes on Payroll, Sales Taxes and VAT; wherein at least of the Tax Categories was created by accessing an online website providing current Tax tables for the Tax Category and the Budget and Cash Flow forecasting Method was updated according to changes in the Tax Category and then displayed to a Company Employee.

14. The improved Budget and Cash Flow Forecasting Method according to claim 11 further having Deficit Spending in one or more future months, with the Method automatically displaying to the User a Revised Budget and Cash Flow analysis after downloading current information on the following and calculating a new debt load: LIBOR, Treasury Bills and COLA (Cost of Living).

15. The improved Budget and Cash Flow Forecasting Method according to claim 11 further having calculated a Budget and Cash Flow analysis for an upcoming Fiscal Year for a first company, with the company having a plurality of sibling companies and a Parent Global Company, the first company combing its Budget and Cash Flow analysis with the Budgets and Cash Flow analysis of sibling corporations and rolling these together to calculate and generate a Global Budget and Cash Flow analysis for the Parent Global Company.

16. The improved Budget and Cash Flow Forecasting Method according to claim 11 further having means to download competitive interest rates from a plurality of financial institutions and displaying same to the User of the Method and the User being able to select the best rate from a plurality of financial institutions and apply for an operating loan during a period of time when cash flow is substantially at a low point and when cash flow is in the negative.

17. The improved Budget and Cash Flow Forecasting Method according to claim 11 further having the ability to post online Budget and Cash Flow information for a Company and the Method being able to provide security against unauthorized access to said information according to at least one of the following security criteria: name of employee, ID of employee, job title of employee and job level of employee.

18. The improved Budget and Cash Flow Forecasting Method according to claim 11 further having the ability to revise its calculations each time an Employee leaves the Company and each time an Employee is hired by the Company.

19. The improved Budget and Cash Flow Forecasting Method according to claim 11 further having means to identify when Cash Flow will be substantially low or in the negative, and the Method triggering an alert to Company employees for a preselected advance period to study and implement optimal funding for the time period in which Cash Flow will be substantially low or in the negative.

20. The improved Budget and Cash Flow Forecasting Method according to claim 11 further having means to offer to clients incentives to pay when Cash Flow is predicted to be substantially low or in the negative, which incentives to pay are selected from one or more of the following groups of Payment Incentives: an offer of a discount for immediate payment; an offer of a payment plan at favorable terms and interest rates, a discount for prepayment on work in progress and a discount of payment for work yet to be done and offer of a flat fee and payment in advance for work that is yet to be done.
